(19) United States
(12) Patent Application Publication
(10) Pub. No.: US 2019/0351854 A1
(43) Pub. Date: Nov. 21, 2019

(54) BUMPER ASSEMBLY AND MANUFACTURING METHOD THEREOF

(71) Applicants: Hyundai Motor Company, Seoul (KR); Kia Motors Corporation, Seoul (KR)

(72) Inventor: Chul-Hong Bae, Suwon (KR)

(21) Appl. No.: 16/367,805

(22) Filed: Mar. 28, 2019

(30) Foreign Application Priority Data
May 18, 2018 (KR) 10-2018-0057049

(51) Int. Cl. B60R 19/18; B60R 19/34; B23K 20/06

(52) U.S. Cl. CPC B60R 19/18; B60R 19/34; B23K 2101/006; B60R 2019/182; B23K 20/06

(57) ABSTRACT

A bumper assembly is provided. The bumper assembly includes a back beam that is disposed within a bumper to absorb an external impact and a collision box that has a hollow tube shape. A first end portion of the collision box is coupled to the back surface of the back beam to receive an impact applied to the back beam and a plate is coupled to a second end portion of the collision box. In particular, the collision box is bonded with the back beam and the plate by an electro magnetic pulse technology method.

### CROSS-REFERENCE TO RELATED APPLICATION

The present application claims priority of Korean Patent Application No. 10-2018-0057049 filed on May 18, 2018, the entire contents of which are incorporated herein by this reference.

### BACKGROUND

### Field of the Disclosure

The present disclosure relates to bumper assembly mounted on a vehicle and a manufacturing method thereof, and more particularly to a bumper assembly that maximizes collision energy absorption performance.

### Description of the Related Art

The bumper assembly including a back beam absorbs the collision energy primarily when the vehicle collides with an external object, thereby preventing damage to major components such as an engine and a transmission, and further preventing injury to the vehicle occupant. The bumper is a shock absorber and the bumpers of the vehicle are mounted on the front and the rear, respectively, to protect the vehicle body from external impact. In passenger vehicles, the bumper has been developed to more efficiently absorb impact energy to minimize occupant injury and major components damage.

Typically, the bumper includes a back beam made to have a particular stiffness, an energy absorber made of urethane material or the like, which is disposed in front of the back beam to absorb the impact, and a bumper cover mounted in front of the energy absorber. Therefore, when relatively small impact energy is generated, the energy absorber absorbers the impact energy and the back beam supports the impact on the rear. However, when a substantial collision energy that the energy absorber is unable to bear is generated, the back beam becomes a cross member of a vehicle to absorb the impact energy. To absorb collision energy more efficiently, as shown in FIG. 1 of the related art, a collision box 2 for supporting the back of the back beam 1 is provided, and an end of the collision box 2 is coupled to the plate 3 coupled to a vehicle body.

The bumper assembly including the back beam, the collision box, and the plate has been replaced with aluminum in accordance with the trend of weight reduction of the vehicle body, although steel material has been conventionally applied. The aluminum bumper assembly is produced by continuous casting of the raw material and is manufactured through the process of extrusion, heat treatment, bending, machining, and melting welding (MIG). As shown in FIG. 1 of the related art, the collision box 2 is joined to a back beam by bolting B and the like, and to the plate 3 by melting welding (MIG).

However, the manufacturing method of such a bumper assembly is relatively expensive due to complex processes, product shape is limited, and yield is deteriorated. Furthermore, although the melting welding (MIG) is performed by automation, welding defects (pore, spatter generation, etc.) are generated depending on the surrounding environment to make the manufacturing quality substantially dispersed. In addition, since the phase change of the basic material and the filler material (solid→liquid→solid) are accompanied, the welding part and the periphery are subjected to heat to cause the mechanical properties to deteriorate compared to the basic material, thereby requiring a design with additional strength reinforcement.

The foregoing is intended merely to aid in the understanding of the background of the present disclosure, and is not intended to mean that the present disclosure falls within the purview of the related art that is already known to those skilled in the art.

### SUMMARY

The present disclosure provides a bumper assembly and manufacturing method thereof capable of maximizing collision energy absorption performance, reducing cost in manufacturing process, and improving quality by implementing a shape that is unable to be implemented in conventional extrusion processes.

A bumper assembly according to an exemplary embodiment of the present disclosure may include a back beam disposed within a bumper to absorb an external impact and a collision box having a hollow tube shape. A first end portion of the collision box may be coupled to a back surface of the back beam to receive an impact applied to the back beam and a plate may be coupled to a second end portion of the collision box. The collision box may be bonded with the back beam and the plate by an electro magnetic pulse tech. method.

Furthermore, a bead may be implemented on the exterior surface of the collision box by the electro magnetic pulse tech. method. The bead may have a circular shape. Additionally, the collision box may have a rectangular cross-section and the bead may be formed on an upper surface, a lower surface, a first side surface and a second side surface of the collision box. Further, an opening portion may be formed on the front surface of the back beam at a position that corresponds to the rear surface to which the collision box is coupled. The collision box may be made of an aluminum material.

A manufacturing method of a bumper assembly according to an exemplary embodiment of the present disclosure may include bonding a first end portion of a collision box having a hollow tube shape to a back beam, bonding a second end portion of the collision box to a plate, and bonding the collision box to the back beam and the plate by an electro magnetic pulse tech. method. Further, a bead of a circular shape may be formed on the exterior surface of the collision box by the electro magnetic pulse tech. method. The collision box may have a rectangular cross-section shape and the bead may be formed on the upper surface, the lower surface and side surfaces of the collision box. The collision box may be made of an aluminum material.

In accordance with a bumper assembly and a manufacturing method thereof according to exemplary embodiments of the present disclosure, an amount of collision energy absorption may be maximized by implementing beads on the collision box surface by the electro magnetic pulse tech. method. Furthermore, manufacturing quality variation due to bolting and welding may be reduced or eliminated by replacing melting welding with the electro magnetic pulse tech. method.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 shows a bumper assembly in the related art;

FIG. 2 shows a bumper assembly according to an exemplary embodiment of the present disclosure;

FIG. 3 is a partially enlarged view of FIG. 2 according to an exemplary embodiment of the present disclosure;

FIG. 4 shows a comparative example of a bumper assembly of the related art for comparison with an exemplary embodiment of the present disclosure; and

FIGS. 5 to 8 show exemplary embodiments of the bumper assembly according to the present disclosure.

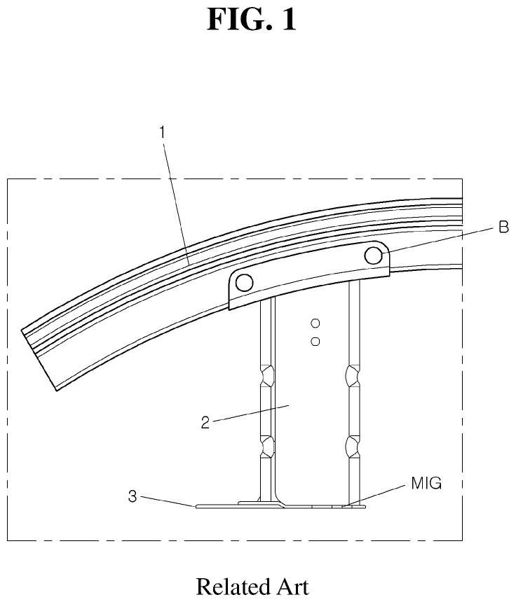

### DETAILED DESCRIPTION

To understand the present disclosure, the operational advantages of the present disclosure, and the objects attained by the practice of the present disclosure, reference should be made to the appended drawings illustrating the exemplary embodiments of the disclosure and the description in the accompanying drawings.

In describing an exemplary embodiment of the present disclosure, known techniques or repetitive descriptions that may unnecessarily obscure the essence of the present disclosure would be either reduced or omitted from the description thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

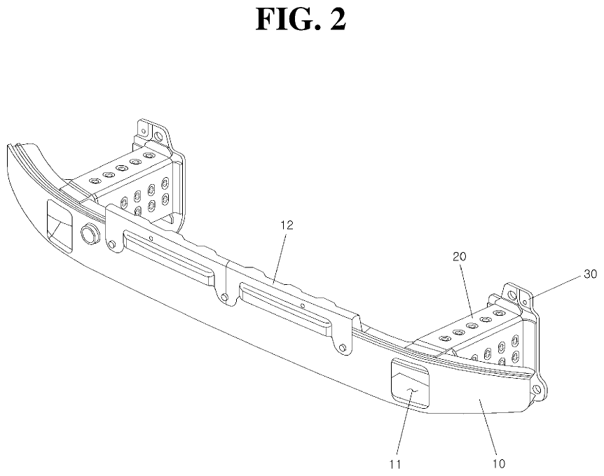

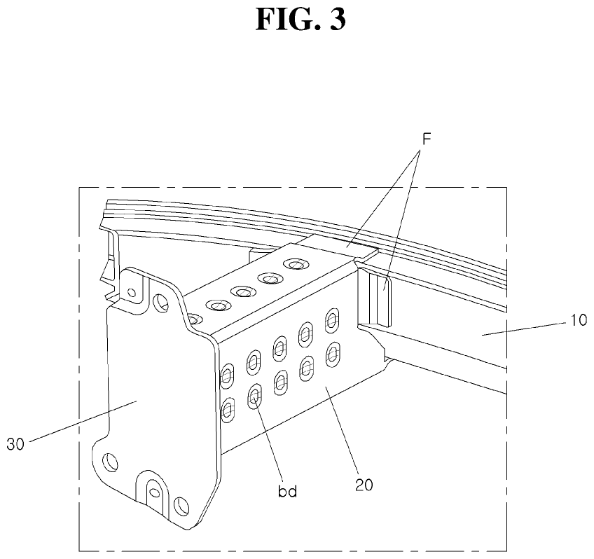

FIG. 2 shows a bumper assembly of the present disclosure and FIG. 3 is a partially enlarged view of FIG. 2. Hereinafter, referring FIGS. 2 and 3, a bumper assembly and a manufacturing method thereof according to an exemplary embodiment of the present disclosure will be described in detail. A bumper assembly according to an exemplary embodiment of the present disclosure may include a back beam 10 disposed within the bumper to absorb an external impact; a collision (e.g., crash) box 20 of an inner hollow tube shape, a first end of which is coupled to the backside of the back beam 10 to receive the impact applied to the back beam 10; and a plate 30 coupled to a second end of the collision box 20.

In addition, an upper reinforcing plate 12 may be coupled to the upper side of the back beam 10. The collision box 20 of the present disclosure may be made of an aluminum material, and the collision box 20 may be coupled to the back beam 10 and the plate 30 by electro magnetic pulse tech., instead of being welded or bolted, to improve the manufacturing process and quality thereof. Furthermore, impact absorption performance may be improved by implementing the bead shape in the collision box 20 by the electro magnetic pulse tech.

Due to the improvement of the impact absorption performance by the collision box 20, an opening 11 may be formed on the front side of the back beam 10 at the position that corresponds to the rear side where the collision box 20 is coupled, and therefore, a closed cross-sectional surface structure may be unnecessary unlike in the related art, thereby reducing the weight and cost.

Flanges F may be formed at both ends of the collision box 20 for coupling the back beam 10 and the plate 30. In the present disclosure, the collision box 20 may be formed by electro magnetic pulse tech. to improve the impact absorption performance. To verify the collision absorption performance, a test specimen of the collision box of an A6063 material joined by electro magnetic pulse tech. with the back beam and the plate of an A1H01 material and another test specimen by melting welding (MIG) were fabricated, and tensile strengths thereof were tested. Table 1 shows the bond strength results for electro magnetic pulse tech. and Tables 2 and 3 are the results for melting welding.

TABLE 1

| TEST | Result value (N) |
|---|---|
| TEST 1 (X1) | 15251.39 |
| TEST 2 (X2) | 12815.66 |
| TEST 3 (X3) | 14118.48 |
| TEST 4 (X4) | 15070.66 |
| TEST 5 (X5) | 14158.62 |
| Average | 14282.96 |

TABLE 2

| FILLET(overlap welding) | Result value (kN) |
|---|---|
| TEST 1 (X1) | 11.34 |
| TEST 2 (X2) | 9.97 |
| TEST 3 (X3) | 10.00 |
| TEST 4 (X4) | 9.75 |
| Average | 10.27 |

TABLE 3

| BUTT(overlap welding) | Result value (kN) |
|---|---|
| TEST 1 (X1) | 6.87 |
| TEST 2 (X2) | 6.06 |
| TEST 3 (X4) | 6.26 |
| TEST 4 (X4) | 5.78 |
| TEST 5 (X6) | 6.77 |
| Average | 6.35 |

The test results show that bond strength may be improved by more than 40% compared to conventional melting welding (MIG). For melting welding, the base metal and the filler metal undergo a solidification process after melting, and a bond strength is lower due to accompanied coarsening of the microstructure. Conversely, the electro magnetic pulse tech. method is a solid state bond and may have high bond strength due to the work hardening phenomenon by plastic deformation of the base material due to high impact.

Based on the results of the test specimens, a prototype was manufactured and a collision test was performed with a truck to verify the performance of the specimen. Truck test condition is a truck speed of 10 Kph and a truck weight of 1,787 kg, and this is calculated as 75% of curb vehicle weight (CVW, 2,295 kg)+77.1 kg+10.5 kg. Barrier intrusion and beam deflection were measured under these conditions.

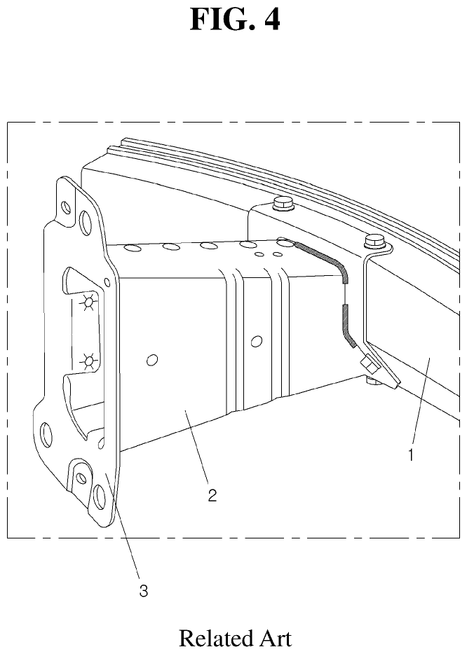

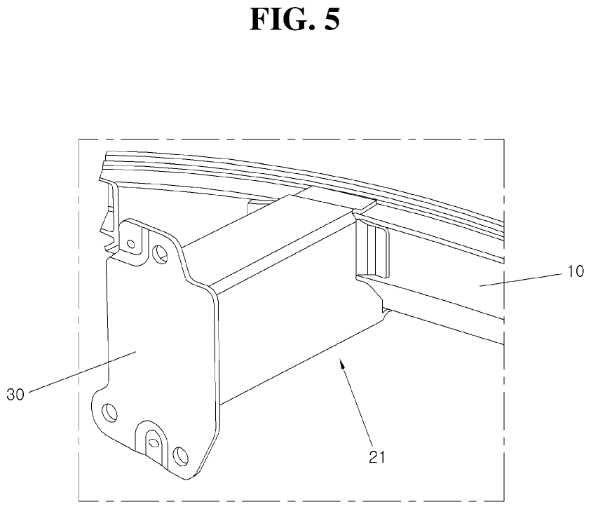

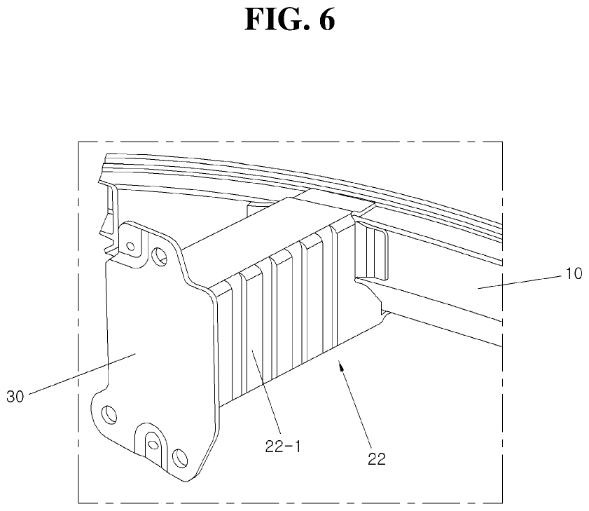

FIG. 4 and FIG. 5 are examples of prototypes for a verification experiment, FIG. 4 is an example of a bumper assembly of the related art for comparison with the present disclosure, and FIG. 5 to FIG. 8 are exemplary embodiments of the bumper assembly of the present disclosure. FIG. 4 shows a collision box 2 of steel material and shows a bead formed on the side surface of the collision box 2 and two line beads on one side surface, which conforms the North American mass production specification. A collision box 21 of FIG. 5 may be made of an aluminum material and without a bead, but may include a bumper assembly bonded by electro magnetic pulse tech. A collision box 22 of FIG. 6 may be made of an aluminum material with beads formed on both side surfaces and five line beads 22-1 formed on one side surface, and may include a bumper assembly bonded by electro magnetic pulse tech.

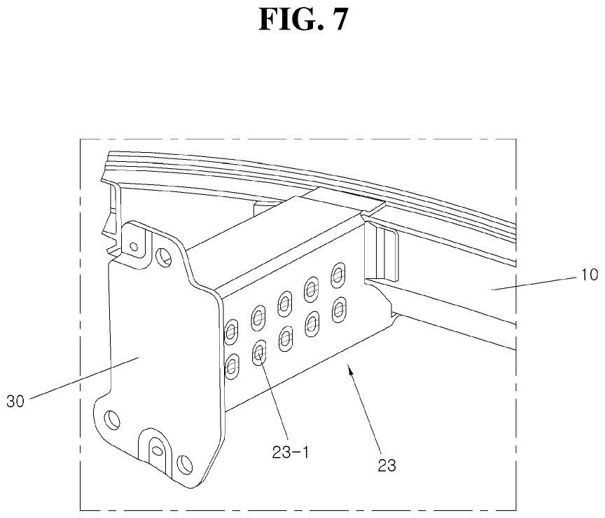

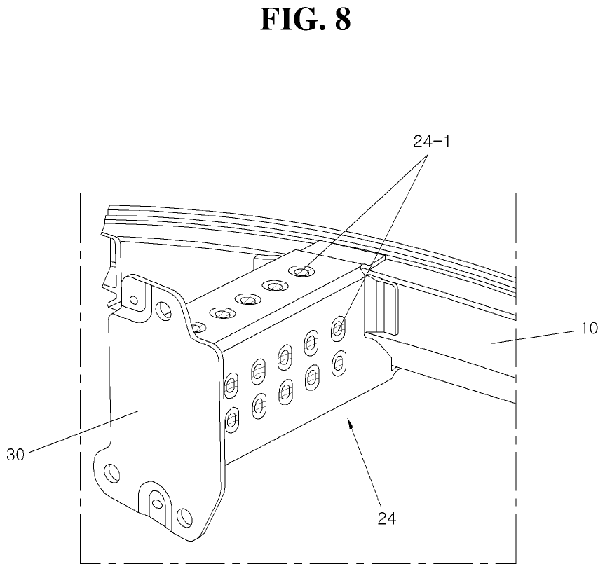

A collision box 23 of FIG. 7 may be made of an aluminum material with beads formed on both side surfaces and ten embossed beads 23-1 formed on one side surface, and may include a bumper assembly bonded by electro magnetic pulse tech. A collision box 24 of FIG. 8 may be made of an aluminum material with beads formed on both side surface, an upper surface and a lower surface, 15 embossed beads formed on one surface among the upper and lower surfaces and one side surface as shown in FIG. 8, and may include a bumper assembly bonded by electro magnetic pulse tech. Table 4 shows the measurement results of intrusion and deflection from the collision test.

TABLE 4

| | | Analysis result values | | | | |
|---|---|---|---|---|---|---|
| | | Comparative | exemplary | exemplary | exemplary | exemplary |
| | | Example | embodiment 1 | embodiment 2 | embodiment 3 | embodiment 4 |
| | Target | (FIG. 4) | (FIG. 5) | (FIG. 6) | (FIG. 7) | (FIG. 8) |
| Item | value | STEEL | No bead | Line bead | Embo 10 | Embo 15 |
| INTRUSION (mm) | 110.5↓ | 110.5 | 107.6 | 107.6 | 108.6 | 108.0 |
| DEFLECTION (mm) | 67.4↓ | 67.4 | 64.4 | 64.5 | 64.5 | 64.4 |

As shown in Table 4, both intrusion and deflection may satisfy the target value in comparison with the comparative example. The intrusion amount of the intrusion barrier was improved by 2.6 mm compared to the comparative example, and the deflection amount of the deflection beam was improved by 3.0 mm compared to the comparative example.

According to the analysis result, the ability to absorb the collision energy may be improved more for the embossed bead, and in addition, a significant improvement may be obtained when uniformly formed on all of the upper and lower surfaces and both side surfaces. The deformation behaviors of the collision box 20 may be different depending on the direction of the applied load, and it is also due to the bond strength by the bond of electro magnetic pulse tech. compared to the conventional melting welding by welding. Moreover, the distal end portion of the collision box may be pre-cut to secure a maximum cross-section that may be bonded to the back beam and the plate to maximize the bonding area when bonding by the electro magnetic pulse tech.

Although the present disclosure has been described with reference to the drawings, it will be apparent to those skilled in the art that the disclosure is not limited to the exemplary embodiments set forth herein but that various modifications and variations may be made without departing from the spirit and scope of the present disclosure. Accordingly, such modifications or exemplary variations should fall within the scope of the claims of the present disclosure, and the scope of the present disclosure should be construed on the basis of the appended claims.

What is claimed is:

1. A bumper assembly, comprising:
a back beam disposed within a bumper to absorb an external impact;
a collision box having a hollow tube shape, a first end portion of which is coupled to a back surface of the back beam to receive an impact applied to the back beam; and
a plate coupled to a second end portion of the collision box,
wherein the collision box is bonded with the back beam and the plate by an electro magnetic pulse technology method.

2. The bumper assembly of claim 1, wherein an exterior surface of the collision box includes a bead implemented by the electro magnetic pulse tech. method.

3. The bumper assembly of claim 2, wherein the bead has a circular shape.

4. The bumper assembly of claim 2, wherein the bead has a linear shape.

5. The bumper assembly of claim 1, wherein the collision box has a rectangular cross-section.

6. The bumper assembly of claim 3, wherein the bead is formed on at least one of an upper surface, a lower surface, a first side surface, or a second side surface of the collision box.

7. The bumper assembly of claim 4, wherein the bead is formed on at least one of an upper surface, a lower surface, a first side surface, or a second side surface of the collision box.

8. The bumper assembly of claim 2, wherein an opening portion is formed on a front surface of the back beam at a position that corresponds to a rear surface to which the collision box is coupled.

9. The bumper assembly of claim 2, wherein the collision box is made of an aluminum material.
